(19) United States
(12) Patent Application Publication
(10) Pub. No.: US 2019/0228320 A1
(43) Pub. Date: Jul. 25, 2019

(54) METHOD, SYSTEM AND TERMINAL FOR NORMALIZING ENTITIES IN A KNOWLEDGE BASE, AND COMPUTER READABLE STORAGE MEDIUM

(71) Applicant: Beijing Baidu Netcom Science and Technology Co., Ltd., Beijing (CN)

(72) Inventors: Zhifan FENG, Beijing (CN); Chao LU, Beijing (CN); Ye XU, Beijing (CN); Zhou FANG, Beijing (CN); Yong ZHU, Beijing (CN); Ying LI, Beijing (CN)

(21) Appl. No.: 16/255,369

(22) Filed: Jan. 23, 2019

(30) Foreign Application Priority Data
Jan. 25, 2018 (CN) 201810073982.5

(51) Int. Cl. G06N 5/02; G06N 20/00; G06K 9/62

(52) U.S. Cl. CPC G06N 5/025; G06K 9/6267; G06N 20/00

(57) ABSTRACT

Systems, methods, terminals, and computer readable storage medium for normalizing entities in a knowledge base. A method for normalizing entities in a knowledge base includes acquiring a set of entities in the knowledge base, pre-segmenting the set of entities in a plurality of segmenting modes, performing a sample construction based on the result of pre-segmentation to extract a key sample, performing a feature construction based on the result of pre-segmentation to extract a similar feature, performing a normalizing determination on each pair of entities with at least one normalization model using the key sample and the similar feature to determine whether entities in each pair are the same, and grouping results of the normalizing determination.

### CROSS-REFERENCE TO RELATED APPLICATION

The present application claims the benefit of priority to Chinese Patent Application No. 201810073982.5, filed before the State Intellectual Property Office on Jan. 25, 2018, and entitled “Method, System and Terminal for Normalizing Entities in a Knowledge Base, and Computer Readable Storage Medium”, which is incorporated in the present application by reference in its entirety.

### TECHNICAL FIELD

The present disclosure relates to the technical field of database construction, and in particular to a method, a system, and a terminal for normalizing entities in a large-scale open domain based on a knowledge base, as well as a computer readable storage medium.

### BACKGROUND

Knowledge base construction is very complicated and difficult. Hence, existing methods are only used in a small-scale and single-vertical type knowledge base (including million to ten-million entities). However, the problem of large-scale entity normalizing cannot be efficiently solved for a large-scale knowledge base (including hundred-million entities). On the other hand, due to large differences between data of the entities, a simple normalizing method can neither solve all the problems in the group, nor support various attributes, categories, and problem scenes in a uniform and efficient manner. Therefore, in the existing methods, entities in the knowledge base are processed in a particular way, that is, an entity with thin attribute information is directly filtered out and not processed, and related processing is further performed on the quality of the entity information.

The above information disclosed in the background is only for understanding of the background of the present disclosure. Therefore, it can contain information that does not constitute the related art known to those skilled in the art.

### SUMMARY

A method, a system, a terminal, and a computer readable storage medium for normalizing entities in a knowledge base, and a computer readable storage medium are provided according to embodiments of the present disclosure, so as to solve at least the above technical problems in the related art.

In an embodiment, a method for normalizing entities in a knowledge base comprises acquiring a set of entities in the knowledge base; pre-segmenting the set of entities in a plurality of segmenting modes into a plurality of entity pairs; performing a sample construction based on the result of pre-segmentation to extract a key sample; performing a feature construction based on the result of pre-segmentation to extract a similar feature; performing a normalizing determination on each entity pair with at least one normalization model using the key sample and the similar feature to determine whether entities in each entity pair are the same; and grouping results of the normalizing determination.

In an embodiment, the plurality of segmenting modes comprises at least first and second segmenting modes, and wherein pre-segmenting the set of entities comprises: segmenting, in the first segmenting mode, the set of entities; and re-segmenting, in the second segmenting mode, the results of segmenting in the first segmenting mode.

In an embodiment, performing the sample construction comprises: performing a first key sample construction based on an attribute; and performing a second key sample construction based on an active learning algorithm.

In an embodiment, performing a first key sample construction comprises: extracting key attributes from each entity pair; based on the extracted key attributes, generating a plurality of new entity pairs by re-segmenting and clustering the entities; and randomly selecting and labeling part of the new entity pairs to obtain the first key sample.

In an embodiment, performing a second key sample construction comprises: (a) labeling part of the plurality of entity pairs in the results of pre-segmentation, to form a labeled sample set including labeled entity pairs and an unlabeled sample set including unlabeled entity pairs; (b) constructing a classification model based on the labeled sample set; (c) inputting the unlabeled entity pairs into the classification model for scoring, and according to the results of scoring, extracting the entity pairs with a boundary score; (d) according to an active learning algorithm, selecting, as a key sample, part of the entity pairs with the boundary score for labeling, and adding the labeled sample to the labeled sample set to obtain a new labeled sample set based on which the classification model is re-trained; and repeating (c) and (d) until the classification model converges, and outputting the labeled sample set obtained by the converged classification model, as the second key sample set.

In an embodiment, performing a feature construction comprises: calculating, with a plurality of feature constructing policies, each of the entity pairs according to the result of pre-segmenting, and outputting result of the calculation as the similar feature.

In an embodiment, when the at least one normalization model comprises a plurality of normalization models, performing, by each of the plurality of normalization models, a normalizing determination on each of the entity pairs according to the result of pre-segmenting, and outputting results of the grouping results of normalizing determinations; and generating a final result of the normalizing determination by fusing each one of the results for normalizing determinations.

In an embodiment, a system for normalizing entities in a knowledge base comprises one or more processors; and one or more storage means configured for storing one or more instructions and encoded with instructions that are executable by the one or more processors to: acquire a set of entities in the knowledge base; pre-segment the set of entities in a plurality of segmenting modes into a plurality of entity pairs; perform a sample construction based on the result of pre-segmentation to extract a key sample; perform a feature construction based on the result of pre-segmentation to extract a similar feature; perform a normalizing determination on each entity pair with at least one normalization model using the key sample and the similar feature to determine whether entities in each entity pair are the same; and group results of the normalizing determination.

In an embodiment, the instructions are further executable by the one or more processors to perform a first sample constructing and a second sample constructing.

In an embodiment, the instructions are further executable by the one or more processors to perform the first sample constructing by extracting key attributes of each of the entity pairs; based on the extracted key attributes, generating a plurality of new entity pairs by re-segmenting and clustering the entities; and randomly selecting and labeling part of the new entity pairs to obtain the first key sample.

In an embodiment, the instructions are further executable by the one or more processors to perform the second sample constructing by labeling part of the plurality of entity pairs in the results of pre-segmentation, to form a labeled sample set including labeled entity pairs and an unlabeled sample set including unlabeled entity pairs; constructing a classification model based on the labeled sample set; inputting the unlabeled entity pairs into the classification model for scoring, and according to the results of scoring, extracting the entity pairs with a boundary score; according to an active learning algorithm, selecting, as a key sample, part of the entity pairs with the boundary score for labeling, and adding the labeled sample to the labeled sample set to obtain a new labeled sample set based on a re-trained classification model; and when that the classification model converges, determining the labeled sample set obtained by the converged classification model as the second key sample set and outputting the second key sample set.

In an embodiment, a non-volatile computer readable storage medium comprising instructions that, when executed by a processor, cause the processor to acquire a set of entities in the knowledge base; pre-segment the set of entities in a plurality of segmenting modes into a plurality of entity pairs; perform a sample construction based on the result of pre-segmentation to extract a key sample; perform a feature construction based on the result of pre-segmentation to extract a similar feature; perform a normalizing determination on each entity pair with at least one normalization model using the key sample and the similar feature to determine whether entities in each entity pair are the same; and group results of the normalizing determination.

In an embodiment, a terminal for normalizing entities in a knowledge base comprises one or more processors; and a storage device configured to store instructions that, when executed by the one or more processors, one or more processors to: acquire a set of entities in the knowledge base; pre-segment the set of entities in a plurality of segmenting modes into a plurality of entity pairs; perform a sample construction based on the result of pre-segmentation to extract a key sample; perform a feature construction based on the result of pre-segmentation to extract a similar feature; perform a normalizing determination on each entity pair with at least one normalization model using the key sample and the similar feature to determine whether entities in each entity pair are the same; and group results of the normalizing determination.

The disclosed technical solution has a number of advantages or advantageous effects. First, with the method according to the present disclosure, a knowledge base of a scale of a hundred million level can be processed, and a multi-vertical type mixed knowledge base can be processed in a unified manner. The knowledge base can include entities with various qualities, which can be processed by the normalizing system using a unified strategy. Second, a large-scale entity set is segmented by using a plurality of segmenting modes in advance for a massive knowledge base, so that the entities to be normalized can be segmented into the same group as much as possible and the number of the entities to be normalized is reduced, thereby breaking through the limits of calculation scale, reducing the calculation amount, while also improving a recall of normalizing. Third, with the multi-model fusion scheme, the problem of supporting multiple-entity data in different scenes and models is solved. In addition, a sample construction is achieved by adopting large-scale key sample construction and human-machine cooperation.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof can be more completely understood in consideration of the following detailed description of various embodiments in connection with the accompanying figures, in which:

FIG. 1 is a flowchart of a method for normalizing entities in a knowledge base, according to an embodiment of the present disclosure.

FIG. 2 is a block diagram of an example construction process, according to an embodiment of the present disclosure.

FIG. 3 is a flowchart of a method for normalizing entities in a knowledge base, according to an embodiment.

FIG. 4 is a block diagram of a system for normalizing entities in a knowledge base, according to an embodiment.

FIG. 5 is a block diagram of a terminal for normalizing entities in a knowledge base according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

### Embodiment 1

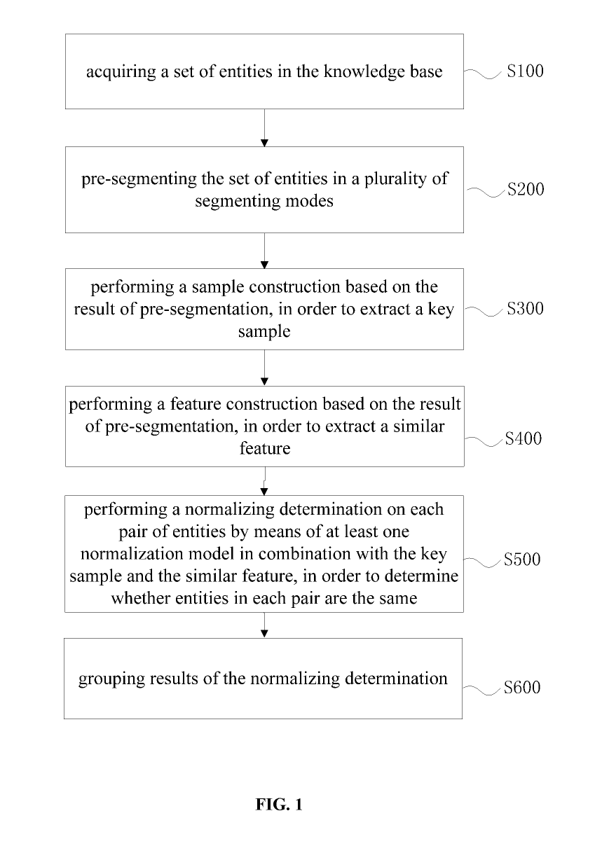

A method for normalizing entities in a knowledge base is provided according to an embodiment of the present disclosure. As shown in FIG. 1, the method can include operations S100 to S600.

At S100, a set of entities in the knowledge base is acquired. The knowledge base can be a knowledge base of a million scale, a ten-million scale or a hundreds-of-million scale. The above knowledge bases of different scales can be a Chinese knowledge graph, or a mixed knowledge base of single-vertical type or multi-vertical type.

At S200, the set of entities in a plurality of segmenting modes is pre-segmented. It should be noted that, in a plurality of segmenting modes, in particular two or more segmenting modes can be applied. In the pre-segmenting, the entities are segmented into a plurality of groups (or a plurality of partitions), and each group includes a plurality of entity pairs in which two entities seemingly indicate a same object. In the segmenting with a plurality of segmenting modes, a plurality of groups obtained by a segmenting mode is re-segmented by another segmenting mode. In this way, entities seemingly indicating the same object can be grouped into the same group as much as possible by considering logics of the plurality of segmenting modes. Hence, the number of entity pairs to be normalized in a subsequent entity normalizing determination step is reduced and the calculation amount is reduced. Even for a large-scale knowledge base with hundred-of-million entities, the breakthrough on calculation scale can be obtained, and the calculation amount of a normalization model is greatly reduced.

In an embodiment, when the plurality of segmenting modes includes a first segmenting mode and a second segmenting mode, in the segmenting, the entities are segmented for a first time by the first segmenting mode to obtain a plurality of first entity groups, and then the plurality of groups obtained by the first segmenting mode is re-segmented by the second segmenting mode to obtain a plurality of second entity groups. As such, the obtained segmenting results are improved again and again.

At S300, a sample construction based on the result of pre-segmentation is performed in order to extract a key sample. S300 can be performed in any number of ways, which is not limited to the ways exemplified in the embodiments of the present disclosure.

At S400, a feature construction based on the result of pre-segmentation is performed in order to extract a similar feature. S400 is performed with any number of ways, which is not limited to the ways exemplified in the embodiments of the present disclosure.

At S500, a normalizing determination on each pair of entities by means of at least one normalization model in combination with the key sample and the similar feature is performed, in order to determine whether entities in each pair are the same.

In an embodiment, there can be a plurality of key samples and a plurality of similar features so that a normalizing determination result obtained by the normalization model is further improved. By the segmenting, the entities are segmented into a plurality of groups, each group including a plurality of entity pairs. In the normalizing determination, the normalizing determination is performed on the plurality of entity pairs in each of the groups. It should be understood that, an entity pair includes two entities. Therefore, the normalizing determination is performed to the two entities to determine whether the two entities are the same, that is, indicate the same object.

At S600, results of the normalizing determination are grouped.

In Embodiment 1, the segmenting mode can be a schema-based segmenting mode, a segmenting mode based on a semantic edge relationship and segmenting mode based on semantic vector clustering. The entities can be segmented with any two or all of the three segmenting modes. The order for performing the segmenting with the three segmenting modes can be determined or changed as required. That is, any one of the segmenting modes can be taken as a first segmenting mode to segment the entities, and any one of the segmenting modes which has not been used can be taken as the last-used segmenting mode.

In a schema-based segmenting mode, a key attribute (or N-Gram, a Chinese language model) of each entity is obtained mainly based on exploration logs, and serves as a criteria of the segmenting.

In Embodiment 1, the key attribute can be the name or alias of an article, the gender, age or body type of a person, the year, country, male and female leading role, or the type of a film, and the like. The above key attributes are only examples. In practical applications, the key attribute in the schema-based segmenting mode according to the present disclosure are not limited to the above examples, and can be arbitrarily selected as required.

In an embodiment, in a segmenting mode based on asemantic edge relationship, the semantic edge relationship (a strategy for establishing a semantic edge relationship is called edge establishment) between entities is used. Generally, entities having a semantic edge relationship with a large number of entities can indicate the same object. For example, if two entities, the Chinese People's Liberation Army General Hospital and the 301 Hospital, both have a semantic edge relationship with four doctors A, B, C and D, the two entities can be considered to indicate the same object. It should be noted that, the segmenting mode based on a semantic edge relationship is mainly used for segmenting the entities. Therefore, the segmenting result obtained in this mode can not be correct, and the obtained result is required to be further determined in combination with other segmenting modes.

In an embodiment, in a segmenting mode based on semantic vector clustering, firstly, by a Deep Neural Network (DNN) technology, an entity is vectorized according to semantic information of the entity and co-occurrence information of the entity. The obtained entity vector can characterize semantic information of the entity (such as semantics described by the entity and semantics of an entity attribute, etc.), and a relationship between two entities (for example, a “couple relationship” between entities “Andy Lau” and “liqian ZHU”). According to the semantic information in combination with a clustering technology, entities that can indicate the same object can be segmented into the same one group. If a segmenting is performed based on the clustering result, the semantic generalization can be achieved.

In Embodiment 1, performing a sample construction includes performing a key sample construction based on an attribute, and performing a second key sample construction can be based on an active learning algorithm.

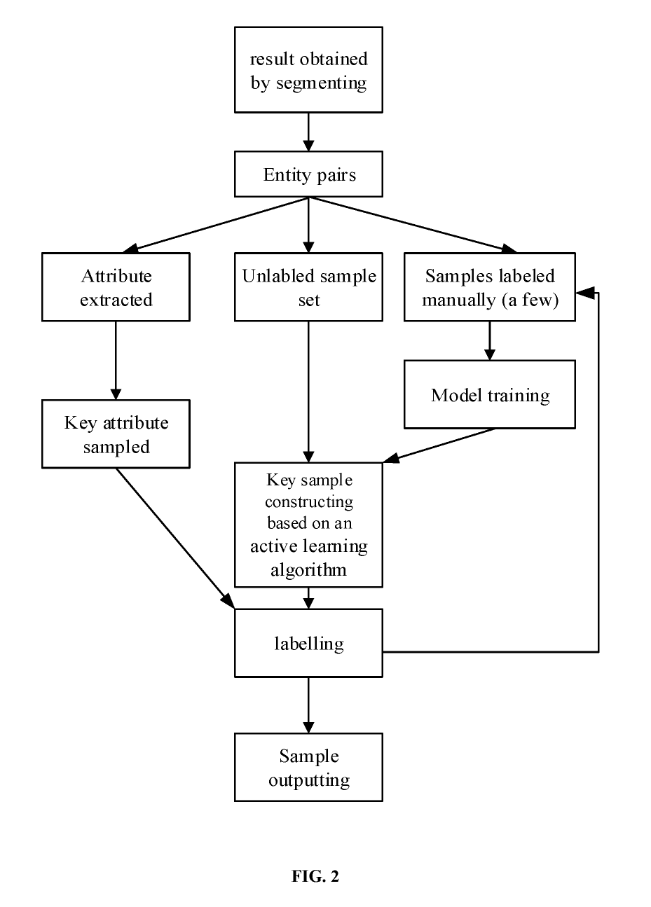

In Embodiment 1, as shown in FIG. 2, performing a first key sample construction can include extracting key attributes of each of the entity pairs in the results of pre-segmentation; and according to the extracted key attributes, generating a plurality of new entity pairs by re-segmenting and clustering the entities; and labeling part of the new entity pairs that randomly selected, to obtain and output the first key sample.

The entity pair can be labeled manually, and a labeling mode by an expert or a crowdsourcing labeling mode can be selected according to a labeling cost. In a case that the knowledge base is of a hundred-million scale, a large amount first key samples are required to be collected for the normalizing determination and grouping.

In an embodiment, a commonly used attribute of a certain type of entities that is obtained via searching logs is determined to be a key attribute for extracting. For example, for a film-type entity, commonly used attributes can be film name, actor, director, releasing date and releasing country or the like.

Referring again to Embodiment 1, as shown in FIG. 2, the performing a second key sample construction can include operations (a)-(d).

At (a) labeling part of the plurality of entity pairs in the results of pre-segmentation forms a labeled sample set and an unlabeled sample set comprising those unlabeled.

At (b), a classification model based on the labeled sample set is constructed. The classification model can be a Gradient Boosting (XGBoost) model.

At (c), the unlabeled entity pairs are input into the classification model for scoring, and according to the results of scoring, a boundary score for the entity pairs is extracted. The threshold score can be about 0.5, or, in a range from 40% to 60% which means that a probability that the two entities indicate the same object is 40%-60%. Therefore, it is difficult to accurately calculate whether the entities in the entity pair indicate the same object by the existing methods.

At (d), according to an active learning algorithm, part of the entity pairs is selected as a key sample with the boundary score for labeling. In embodiments, the labeled sample can be added to the labeled sample set to obtain a new labeled sample set based on which the classification model being re-trained.

In an embodiment, when there are too many entity pairs with the threshold score, a certain number of the entity pairs with the threshold score are selected according to a search criteria and then labeled. The labeling can be expert labeling or crowdsourcing labeling. Since an entity pair that cannot be determined with the scoring model are labeled, by training, the classification model can be optimized and improved, that is, it is possible to determine whether the entities of the selected entity pair with the threshold score indicate the same object.

To further improve the classification model, (c) and (d) can be performed repeatedly until the classification model converges. That is, when the unlabeled sample set can be accurately determined and a result obtained by the classification model and efficiency of the classification model can meet a preset standard, iteration on the classification model is ended. The labeled sample set obtained after the iteration is output as a second key sample set.

In Embodiment 1, the active learning algorithm can include an algorithm based on a maximizing information amount, expected error reduction algorithm (least expected error algorithm) or minimum version space algorithm (minimum interpretation space algorithm).

In an algorithm based on the maximized information amount, an unlabeled entity pair can cause the current model to potentially change a lot (i.e., containing much information), such that an entity with a preset threshold are selected and labeled. In the algorithm based on the maximized information amount, an entity pair that is most difficult to be determined is selected, and thus, the algorithm is called an uncertainty sampling algorithm.

In an expected error reduction algorithm, by considering from a global perspective, an entity pair with the least expected error (risk) is labeled. The essential process of this algorithm is to calculate an expectance of a global error after an entity pair is added to the labeled sample set.

In a minimum version space algorithm, all of the statistical learning models that are consistent with a labeled entity set are referred to as aversion space of the entity set. The larger the version space is, the more the models therein can be selected. In a case that the version space has only one element, the statistical learning model can also be uniquely determined. Therefore, in another active learning algorithm, an entity pair enabling to minimize the version space is selected and labeled.

Referring again to Embodiment 1, the performing a feature construction can include: calculating, with a plurality of feature constructing policies, each of the entity pairs according to the result of pre-segmenting, and outputting result of the calculation as the similar feature. A plurality of feature construction policies can be applied, which include two or more feature construction policies. It is understood that applying the plurality of feature construction policies can include performing calculation on the entity pairs by any one of the policies, and then performing calculating on a result, obtained by performing the feature construction policy, by another feature construction policy, so as to obtain a more accurate similar feature.

In an embodiment, the plurality of feature construction policies include a first feature construction policy and a second feature construction policy. The entity pairs obtained by the segmenting are calculated with the first feature construction policy firstly to obtain a first calculating result. Then, the first calculating result is calculated with the second feature construction policy to obtain a second calculating result, i.e. the similar feature, so as to improve obtained similar feature.

In an embodiment, the feature construction policy includes: a textual similar feature, a textual semantic feature, and a structural semantic feature. The textual similar feature can include text co-occurrence, key phrase (phrase) co-occurrence, attribute value overlapping, and the like. The text semantic features can be similar features of a semantic level, including a text semantic similarity, a key phrase semantic similarity, and a key attribute value semantic similarity, and the like. The structural semantic features can be similar features of a map structure formed by connecting entities. For example, the entity “Liu dehua” has many attribute edges, such as “wife: Zhu liqian”, “daughter: Liu xianghui” and “works: Infernal Affairs, A World Without Thieves, Running Out of Time”, and other edge relationships formed by extending these attribute edges. In this case, an entity normalizing determination can be performed by taking the similarity of these semantic edges as a feature. In the aforementioned three feature construction policies, the similar features are all calculated with comparison operators. The comparison operator includes a large quantity of attribute similarity calculation plugins, which can also be customized by a user.

In an embodiment, the normalizing model can be a Bayesian inference model, a machine learning classification model, or a normalizing model based on a Siamese neural network model.

In a Bayesian inference model, attribute importance and comparison modes are configured by a user based on the key sample and the similar feature, and then the normalizing determination is performed based on a Bayesian inference formula. The principle of the Bayesian inference model is to calculate the entity similarity based on a prior probability of attribute comparison. The model is mainly implemented in a plugin “bayes.comparer” in which an initial probability is 0.5, and is gradually modified with a probability obtained in the attribute similarity calculation.

In a machine learning classification model, the normalizing determination can be considered to be the classifying in machine learning by a classifying model that is trained based on the key sample and the similar feature. That is, it is determined by the classifying model whether two given entities indicate the same object. The XGBoost model is adopted as the classifying model, and a GridSearch is adopted for automatic parameter searching. The normalizing determination based on the Bayesian inference mainly solves a problem requiring quick effect. A high-accuracy normalizing determination policy can be manually generated quickly in a semi-self-help mode for supporting an application.

In a normalizing determination model based on the Siamese neural network, the model based on machine learning classification strongly depends on a construction of a feature system, and the quality of the feature construction can affect the effect of the model to a large extent. Based on accumulated large batches of effective training samples (samples in the key sample set and the key feature set), the DNN technology can automatically perform an encoding and learning on the key features using a large quantity of the training samples. The normalizing determination based on the machine learning classification model can be used for manually constructing the key features and the training samples, and can complete a medium/high-accuracy normalizing model within one to three days, and put the normalizing model into an application.

The normalizing determination of two entities to indicate the same object can be handled by adopting a Siamese peer-to-peer network structure. A framework of the structure can include three components: an input layer construction, a network structure layer, and a loss function using a standard comparison operator. For the input layer construction, inputs include attribute information (each attribute and the value thereof are input directly) of two entities for the normalizing determination and original features in the machine learning classification. The network structure layer includes a Convolutional Neural Network (CNN) and a maximum pooling layer which are connected to a Long Short-Term Memory (LSTM) layer.

In an embodiment, if a plurality of normalizing models are used, it is determined whether two entities of each entity pair in the pre-segmenting result indicate a same object by each normalizing model, and outputting results of the grouping results of normalizing determinations respectively. In embodiments, the grouping results of the normalizing determination can include generating a final result of the normalizing determination by fusing each one of the results for normalizing determinations.

In an embodiment, the grouping results of the normalizing determination is based on the results of the normalizing determination and performed using a Union-Find algorithm, so as to obtain an entity set. After the performing the grouping, the entity set is input into the knowledge base to normalize and disambiguate information in the knowledge base.

In a case where a new entity set comprising a plurality of entities is input into the knowledge base, the normalizing determination and grouping can be performed on the new entity set by the above method according to the present disclosure. In addition, after the obtained entity set is input into the knowledge base, it is required to fuse related entities. For example, two entities indicating the same object and with a few pieces of different information therein are fused. For example, entities “Liudehua” and “Huazai” substantively represent the same person, i.e., indicate the same object, although they have different names.

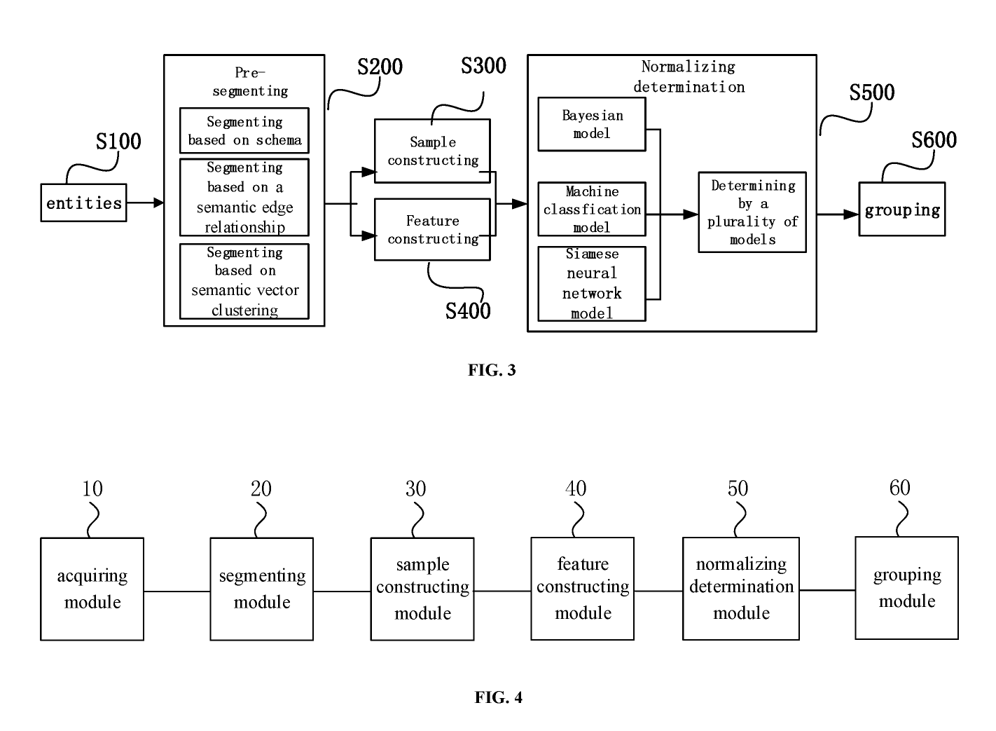

Referring to FIG. 3, the method for normalizing entities in a knowledge base can include S100: acquiring a set of entities in the knowledge base; S200: pre-segmenting the set of entities using three segmenting modes; wherein the three segmenting modes include a schema-based segmenting mode, a segmenting mode based on a semantic edge relationship and a segmenting mode based on semantic vector clustering; S300: performing a sample construction based on the result of pre-segmentation, in order to extract a key sample; S400: performing a feature construction based on the result of pre-segmentation, in order to extract a similar feature; S500: performing a normalizing determination on each pair of entities by means of three normalizing models, in order to determine whether entities in each pair are the same, wherein the three normalizing models include a Bayesian inference model, a machine learning classification model, or a grouping model based on a Siamese neural network model; and S600: generating a final result of the normalizing determination by fusing each one of the results for normalizing determinations according to a fusion strategy by a voting manner, to group results of the normalizing determination.

### Embodiment 2

A system for normalizing entities in a knowledge base is provided according to an embodiment. As shown in FIG. 4, the system can include an acquiring module 10, configured for acquiring a set of entities in the knowledge base; a segmenting module 20, configured for pre-segmenting the set of entities in a plurality of segmenting modes; a sample constructing module 30, configured for performing a sample construction based on the result of pre-segmentation, in order to extract a key sample; a feature constructing module 40, configured for performing a feature construction based on the result of pre-segmentation, in order to extract a similar feature; a normalizing determination module 50, configured for, performing a normalizing determination on each pair of entities by means of at least one normalization model in combination with the key sample and the similar feature, in order to determine whether entities in each pair are the same; and a grouping module 60, configured for grouping results of the normalizing determination.

In an embodiment, the sample constructing module 30 includes a first sample constructing module and a second sample constructing module.

In one embodiment, the first sample constructing module includes: a key attribute sub-module configured for extracting key attributes of each of the entity pairs in the results of pre-segmentation; and according to the extracted key attributes, generating a plurality of new entity pairs by re-segmenting and clustering the entities; and a first outputting sub-module configured for labeling part of the new entity pairs that randomly selected, to obtain and output the first key sample.

In an embodiment, the second sample constructing module includes: a sample sub-module, configured for labeling part of the plurality of entity pairs in the results of pre-segmentation, to form a labeled sample set and an unlabeled sample set comprising those unlabeled; a modeling sub-module, configured for constructing a classification model based on the labeled sample set; a calculating sub-module, configured for inputting the unlabeled entity pairs into the classification model for scoring, and according to the results of scoring, extracting the entity pairs with a boundary score; an iteration sub-module, configured for, according to an active learning algorithm, selecting, as a key sample, part of the entity pairs with the boundary score for labeling, and adding the labeled sample to the labeled sample set to obtain a new labeled sample set based on which the classification model being re-trained; and a second outputting sub-module configured for, in a case that the classification model converges, determining the labeled sample set obtained by the converged classification model as the second key sample set and outputting the second key sample set.

### Embodiment 3

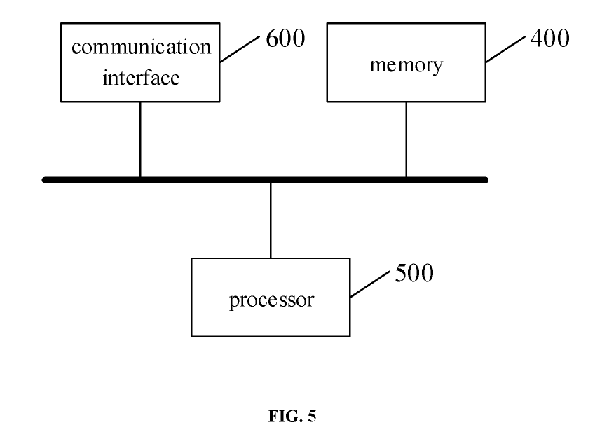

In an embodiment, a terminal for normalizing entities in a knowledge base is provided according to an embodiment. As shown in FIG. 5, the terminal can include a memory 400 and a processor 500, wherein a computer program that can run on the processor 500 is stored in the memory 400; when the processor 500 executes the computer program, the method for knowledge base entity normalization in the above embodiment is implemented; the number the memory 400 and the processor 500 can each be one or more; and a communication interface 600, configured to enable the memory 400 and the processor 500 to communicate with an external device.

The memory 400 can include a high-speed RAM memory, or can also include a non-volatile memory, such as at least one disk memory. If the memory 400, the processor 500 and the communication interface 600 are implemented independently, the memory 400, the processor 500 and the communication interface 600 can be connected to each other via a bus so as to realize mutual communication. The bus can be an industry standard architecture (ISA) bus, a peripheral component interconnect (PCI) bus, an extended industry standard architecture (EISA) bus, or the like. The bus can be categorized into an address bus, a data bus, a control bus or the like. For ease of illustration, only one bold line is shown in FIG. 5 to represent the bus, but it does not mean that there is only one bus or only one type of bus.

Optionally, in an embodiment, if the memory 400, the processor 500 and the communication interface 600 are integrated on one chip, then the memory 400, the processor 500 and the communication interface 600 can complete mutual communication through an internal interface.

### Embodiment 4

In an embodiment, a computer readable storage medium having a computer program stored thereon that, when executed by a processor, implements the method for normalizing entities in a knowledge base as described in any of the above embodiments.

In the present specification, the description referring to the terms “one embodiment”, “some embodiments”, “an example”, “a specific example”, or “some examples” or the like means that the specific features, structures, materials, or characteristics described in connection with the embodiment or example are contained in at least one embodiment or example of the disclosure. Moreover, the specific features, structures, materials, or characteristics described can be combined in a suitable manner in any one or more embodiments or examples. In addition, various embodiments or examples described in the specification as well as features of different embodiments or examples can be united and combined by those skilled in the art, as long as they do not contradict with each other.

Furthermore, terms “first” and “second” are used for descriptive purposes only, and are not to be construed as indicating or implying relative importance or implicitly indicating the number of recited technical features. Thus, a feature defined with “first” and “second” can include at least one said feature, either explicitly or implicitly. In the description of the present disclosure, the meaning of “a plurality” is two or more than two, unless otherwise explicitly or specifically indicated.

Any process or method described in the flowcharts or described otherwise herein can be construed as representing a module, segment or portion including codes for executing one or more executable instructions for implementing a particular logical function or process steps. The scope of the preferred embodiments of the present disclosure includes additional implementations in which functions can be implemented in an order that is not shown or discussed, including in a substantially concurrent manner or in a reverse order based on the functions involved. All these should be understood by those skilled in the art to which the embodiments of the present disclosure belong.

The logics and/or steps represented in the flowchart or otherwise described herein for example can be considered as an ordered list of executable instructions for implementing logical functions. They can be specifically embodied in any computer-readable medium for use by an instruction execution system, apparatus or device (e.g., a computer-based system, a system including a processor, or another system that can obtain instructions from the instruction execution system, apparatus or device and execute these instructions) or for use in conjunction with the instruction execution system, apparatus or device. For the purposes of the present specification, “computer-readable medium” can be any means that can contain, store, communicate, propagate or transmit programs for use by an instruction execution system, apparatus or device or for use in conjunction with the instruction execution system, apparatus or device.

The computer-readable medium described in the embodiments can a computer-readable signal medium or a computer-readable storage medium or any combination of a computer-readable signal medium and a computer-readable storage medium. More specific examples (non-exhaustive list) of computer-readable storage medium at least include: electrical connection parts (electronic devices) having one or more wires, portable computer disk cartridges (magnetic devices), random access memory (RAM), read only memory (ROM), erasable programmable read-only memory (EPROM or flash memory), fiber optic devices, and portable read only memory (CDROM). In addition, the computer-readable storage medium can even be a paper or other suitable medium on which the programs can be printed. This is because for example the paper or other medium can be optically scanned, followed by editing, interpretation or, if necessary, other suitable ways of processing so as to obtain the programs electronically, which are then stored in a computer memory.

In an embodiment, the computer-readable signal medium can include a data signal propagating in a baseband or as a part of a carrier, in which computer-readable program codes are carried. Such propagating data signal can take a variety of forms including, but not limited to, electromagnetic signals, optical signals, or any suitable combination of the electromagnetic signals and optical signals. The computer-readable signal medium can also be any computer-readable medium other than a computer-readable storage medium, and the computer-readable medium can send, propagate or transmit a program for use by an instruction execution system, an input method, or a device or for use in conjunction with an instruction execution system, an input method, or a device. The program codes embodied in the computer-readable medium can be transmitted by any suitable medium, including but not limited to: wireless, wire, optic cable, radio frequency (RF), etc., or any suitable combination of the foregoing.

Various embodiments of systems, devices, and methods have been described herein. These embodiments are given only by way of example and are not intended to limit the scope of the claimed inventions. It should be appreciated, moreover, that the various features of the embodiments that have been described can be combined in various ways to produce numerous additional embodiments. Moreover, while various materials, dimensions, shapes, configurations and locations, etc. have been described for use with disclosed embodiments, others besides those disclosed can be utilized without exceeding the scope of the claimed inventions.

Persons of ordinary skill in the relevant arts will recognize that the subject matter hereof can comprise fewer features than illustrated in any individual embodiment described above. The embodiments described herein are not meant to be an exhaustive presentation of the ways in which the various features of the subject matter hereof can be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim can refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A method for normalizing entities in a knowledge base, the method comprising:
acquiring a set of entities in the knowledge base;
pre-segmenting the set of entities in a plurality of segmenting modes into a plurality of entity pairs;
performing a sample construction based on the result of pre-segmentation to extract a key sample;
performing a feature construction based on the result of pre-segmentation to extract a similar feature;
performing a normalizing determination on each entity pair with at least one normalization model using the key sample and the similar feature to determine whether entities in each entity pair are the same; and
grouping results of the normalizing determination.

2. The method of claim 1, wherein the plurality of segmenting modes comprises at least first and second segmenting modes, and wherein pre-segmenting the set of entities comprises:
segmenting, in the first segmenting mode, the set of entities; and
re-segmenting, in the second segmenting mode, the results of segmenting in the first segmenting mode.

3. The method of claim 1, wherein performing the sample construction comprises:
performing a first key sample construction based on an attribute; and
performing a second key sample construction based on an active learning algorithm.

4. The method of claim 3, wherein the performing a first key sample construction comprises:
extracting key attributes from each entity pair;
based on the extracted key attributes, generating a plurality of new entity pairs by re-segmenting and clustering the entities; and
randomly selecting and labeling part of the new entity pairs to obtain the first key sample.

5. The method of claim 3, wherein the performing a second key sample construction comprises:
(a) labeling part of the plurality of entity pairs in the results of pre-segmentation, to form a labeled sample set including labeled entity pairs and an unlabeled sample set including unlabeled entity pairs;
(b) constructing a classification model based on the labeled sample set;
(c) inputting the unlabeled entity pairs into the classification model for scoring, and according to the results of scoring, extracting the entity pairs with a boundary score;
(d) according to an active learning algorithm, selecting, as a key sample, part of the entity pairs with the boundary score for labeling, and adding the labeled sample to the labeled sample set to obtain a new labeled sample set based on which the classification model is re-trained; and
repeating (c) and (d) until the classification model converges, and outputting the labeled sample set obtained by the converged classification model, as the second key sample set.

6. The method of claim 1, wherein the performing a feature construction comprises:
calculating, with a plurality of feature constructing policies, each of the entity pairs according to the result of pre-segmenting, and outputting result of the calculation as the similar feature.

7. The method of claim 1, wherein when the at least one normalization model comprises a plurality of normalization models,
performing, by each of the plurality of normalization models, a normalizing determination on each of the entity pairs according to the result of pre-segmenting, and outputting results of the grouping results of normalizing determinations; and
generating a final result of the normalizing determination by fusing each one of the results for normalizing determinations.

8. A system for normalizing entities in a knowledge base, the system comprising:
one or more processors; and
one or more storage means configured for storing one or more instructions and encoded with instructions that are executable by the one or more processors to:
acquire a set of entities in the knowledge base;
pre-segment the set of entities in a plurality of segmenting modes into a plurality of entity pairs;
perform a sample construction based on the result of pre-segmentation to extract a key sample;
perform a feature construction based on the result of pre-segmentation to extract a similar feature;
perform a normalizing determination on each entity pair with at least one normalization model using the key sample and the similar feature to determine whether entities in each entity pair are the same; and
group results of the normalizing determination.

9. The system of claim 8, wherein the instructions are further executable by the one or more processors to perform a first sample constructing and a second sample constructing.

10. The system of claim 9, wherein the instructions are further executable by the one or more processors to perform the first sample constructing by:
extracting key attributes of each of the entity pairs;
based on the extracted key attributes, generating a plurality of new entity pairs by re-segmenting and clustering the entities; and
randomly selecting and labeling part of the new entity pairs to obtain the first key sample.

11. The system of claim 9, wherein the instructions are further executable by the one or more processors to perform the second sample constructing by:
labeling part of the plurality of entity pairs in the results of pre-segmentation, to form a labeled sample set including labeled entity pairs and an unlabeled sample set including unlabeled entity pairs;
constructing a classification model based on the labeled sample set;
inputting the unlabeled entity pairs into the classification model for scoring, and according to the results of scoring, extracting the entity pairs with a boundary score;
according to an active learning algorithm, selecting, as a key sample, part of the entity pairs with the boundary score for labeling, and adding the labeled sample to the labeled sample set to obtain a new labeled sample set based on a re-trained classification model; and
when that the classification model converges, determining the labeled sample set obtained by the converged classification model as the second key sample set and outputting the second key sample set.

12. A non-volatile computer readable storage medium comprising instructions that, when executed by a processor, cause the processor to:
acquire a set of entities in the knowledge base;
pre-segment the set of entities in a plurality of segmenting modes into a plurality of entity pairs;
perform a sample construction based on the result of pre-segmentation to extract a key sample;
perform a feature construction based on the result of pre-segmentation to extract a similar feature;
perform a normalizing determination on each entity pair with at least one normalization model using the key sample and the similar feature to determine whether entities in each entity pair are the same; and
group results of the normalizing determination.
